(19) United States
(12) Patent Application Publication
(10) Pub. No.: US 2007/0171669 A1
(43) Pub. Date: Jul. 26, 2007

(54) BACKLIGHT ASSEMBLY AND LIQUID CRYSTAL DISPLAY DEVICE HAVING THE SAME

(76) Inventors: Sang-Gil Lee, Seoul (KR); Hyeon-Yong Jang, Osan-si (KR)

Correspondence Address: F. CHAU & ASSOCIATES, LLC, 130 WOODBURY ROAD, WOODBURY, NY, 11797, US

(21) Appl. No.: 11/626,035

(22) Filed: Jan. 23, 2007

(30) Foreign Application Priority Data
Jan. 23, 2006 (KR) 2006-6710

(51) Int. Cl. F21V 7/04

(52) U.S. Cl. 362/600

(57) ABSTRACT

A backlight assembly includes an optical cluster a light-receiving structure, a light sensor and a circuit board. The optical cluster includes a plurality of point-light sources that emit different light beams. The light-receiving structure is disposed within an emitting area of the optical cluster, and receives the light beams emitted from each of the point-light sources. The light sensor is connected to the light-receiving structure, and senses the light beams received from the light-receiving structure. The optical cluster is mounted on the circuit board. The circuit board has an opening formed within the emitting area of the optical cluster, so that the light-receiving structure may be inserted into the circuit board. Therefore, intensity of light received by the light-receiving structure disposed within the optical cluster may be sensed, so that white balance may be controlled.

### CROSS-REFERENCE TO RELATED APPLICATION

This application claims priority to Korean Patent Application No. 2006-6710 filed on Jan. 23, 2006, the contents of which are herein incorporated by reference in their entirety.

### BACKGROUND OF THE INVENTION

1. Technical Field

The present disclosure relates to a backlight assembly and, more particularly, to a backlight assembly capable of controlling white balance, and a liquid crystal display device having the backlight assembly.

2. Discussion of the Related Art

A display device displays images by converting electronic data into a visible image, which is processed by an information processing apparatus. Various types of display devices include cathode ray tubes (“CRT”), plasma display panels (“PDP”), liquid crystal display (“LCD”) devices, and organic electro-luminescent display (“OELD”) devices. The LCD device displays images by using liquid crystal, of which electrical and optical characteristics vary in response to an electric field applied thereto. The LCD device has been widely used in various electronic devices, because the LCD device is light weight, thin thickness, and consumes low power, in comparison with other display devices.

The LCD device is a non-emissive type display device, and thus the LCD device includes a light source, such as a backlight assembly to supply an LCD panel of the LCD device with light.

A conventional LCD device mainly employ a light source, such as a cold cathode fluorescent lamp (“CCFL”), or a flat fluorescent lamp (“FFL”), which emits white light.

In order to enhance color reproducibility, an LCD device that employs a light source including a red light-emitting diode (LED), a green LED and a blue LED, has been developed. Particularly, in order to enhance the color reproducibility, white balance for different types of monochromatic light emitted from each of the red, green and blue LEDs may be controlled in accordance with a color filter of an LCD panel.

### SUMMARY OF THE INVENTION

Embodiments of the present invention provide a backlight assembly capable of controlling white balance by sensing colored light, and a liquid crystal display (“LCD”) device having the above-mentioned backlight assembly.

In one embodiment of the present invention, a backlight assembly includes an optical cluster, a light-receiving structure, a light sensor and a circuit board. The optical cluster includes a plurality of point-light sources that emit different light beams. The light-receiving structure is disposed within an emitting area of the optical cluster, and receives the light beams that are emitted from the point-light sources. The light sensor is connected to the light-receiving structure, and senses the light beams that are received from the light-receiving structure. The optical cluster may be mounted on the circuit board. The circuit board has an opening formed within the emitting area of the optical cluster, so that the light-receiving structure may be inserted into the circuit board.

The backlight assembly may further include a power-providing apparatus that provides the point-light source with power. The power-providing apparatus controls a driving voltage that is applied to the point-light source in response to the light-sensing signal received from the light sensor.

The point-light sources may be disposed on a plane, and each point-light source may include a light-emitting diode (“LED”).

The light-receiving structure may include a plurality of light-receiving surfaces facing each of the point-light sources, respectively. The light-receiving surfaces may be substantially inclined with respect to a plane having the point-light sources disposed thereon. Also, the light-receiving surfaces may be substantially perpendicular to a path of light emitted from the point-light sources.

The backlight assembly may further include a diffusion plate that diffuses and reflects the light beams that are emitted from the optical cluster. The light-receiving structure may further include a light-blocking member that blocks the light beams that are reflected by the diffusion plate. Here, the upper portion of the light-receiving structure faces the diffusion plate.

The optical clusters may be disposed on a plane. The light-receiving structure may be disposed in the optical cluster that is disposed within an outer area of the backlight assembly, for example, near an edge of or in a corner of the backlight assembly. The light sensor may be disposed at an end portion of the light-receiving structure and may sense an intensity of each light beam.

In another embodiment of the present invention, an LCD device includes an LCD panel and a backlight assembly. The LCD panel displays images using a liquid crystal layer that is interposed between two substrates. The backlight assembly includes an optical cluster and a light-receiving structure that is disposed within an emitting area of the optical cluster. The backlight assembly provides the LCD panel with light.

The backlight assembly may include a plurality of optical clusters and the light-receiving structure is within an outermost optical cluster of the plurality of optical clusters.

In accordance with embodiments of the present invention, in a backlight assembly and a liquid crystal display device having the same, an intensity of light received by the light-receiving structure that is disposed in an emitting area of the optical cluster may be sensed, so that white balance may be controlled.

### BRIEF DESCRIPTION OF THE DRAWINGS

Embodiments of the present invention can be understood in more detail from the following descriptions taken in conjunction with the accompanying drawings wherein:

FIG. 1 is an exploded perspective view schematically illustrating a liquid crystal display (“LCD”) device according to an exemplary embodiment of the present invention;

FIG. 2 is a plan view illustrating the light-generating unit in FIG. 1 according to an exemplary embodiment of the present invention;

FIG. 3 is a perspective view illustrating a light-receiving structure in FIG. 1 according to an exemplary embodiment of the present invention;

FIG. 4 is a perspective cross-sectional view illustrating an optical cluster and a light-receiving structure in FIG. 1 according to an exemplary embodiment of the present invention;

FIG. 5 is a cross-sectional view schematically illustrating a light-receiving structure receiving light according to an exemplary embodiment of the present invention;

FIG. 6 is a perspective view illustrating a light-receiving structure according to an exemplary embodiment of the present invention; and

FIG. 7 is a cross-sectional view schematically illustrating a light-receiving structure of an optical cluster having the light-receiving structure in FIG. 6 according to an exemplary embodiment of the present invention.

### DESCRIPTION OF EXEMPLARY EMBODIMENTS

Exemplary embodiments of the present invention are described more fully hereinafter with reference to the accompanying drawings. This invention may, however, be embodied in many different forms and should not be construed as limited to the embodiments set forth herein. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present.

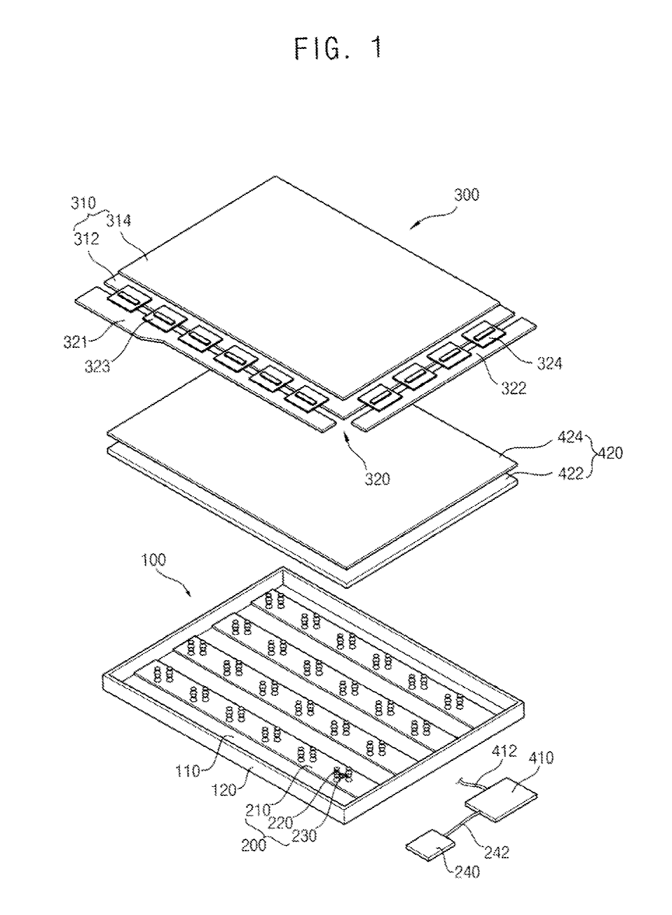

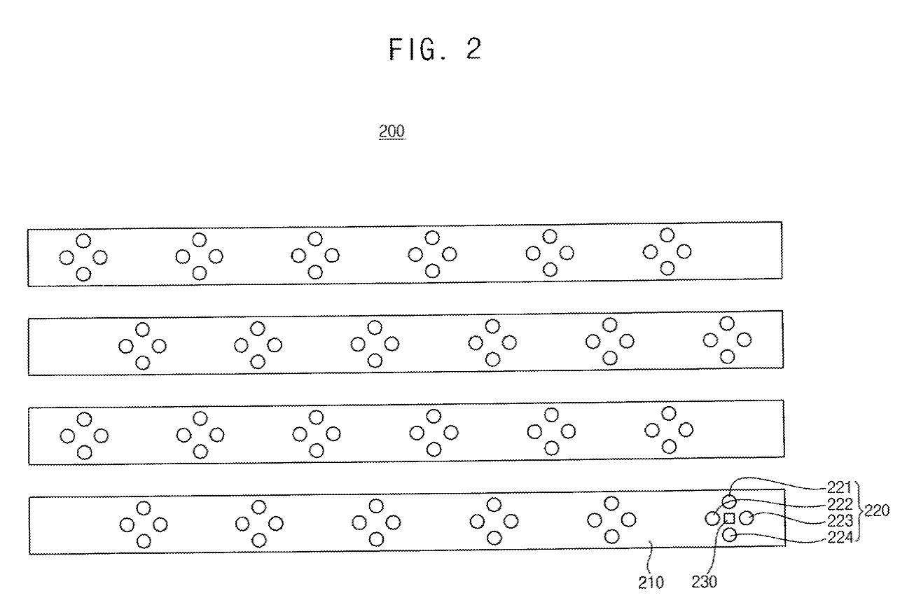

FIG. 1 is an exploded perspective view schematically illustrating a liquid crystal display (“LCD”) device according to an exemplary embodiment of the present invention. FIG. 2 is a plan view illustrating the light-generating unit in FIG. 1.

Referring to FIGS. 1 and 2, an LCD device includes a receiving container 100, a light-generating unit 200 and an LCD panel unit 300.

The receiving container 100 includes a bottom section 110 and a side section 120 that is extended from edge portions of the bottom section 110 to define a receiving space. The receiving container 100 receives the light-generating unit 200. The receiving container 100 includes, for example, a metal having high strength and low deformity.

The light-generating unit 200 is disposed on the bottom section 110 of the receiving container 100. The light-generating unit 200 includes a plurality of circuit boards 210 and a plurality of optical clusters 220 that are disposed on each of the circuit boards 210, and that generate light.

The light-generating unit 200 is disposed under the LCD panel unit 300, so that the light-generating unit 200 defines a backlight assembly. Each of the optical clusters 220 includes a plurality of point-light sources that emit different light beams. The point-light sources may be driven by a local dimming method that optionally emits some of the point-light source groups by predetermined areas.

In the present exemplary embodiment, each of the optical clusters 220 includes a red point-light source 221 that emits a red light beam, a first green point-light source 222 that emits a first green light beam, a second green point-light source 223 that emits a second green light beam, and a blue point-light source 224 that emits blue light beam. Therefore, points in time when and periods during which each of the red point-light sources 221 are emitted may be different from each other. Furthermore, points in time when and periods during which each of the first and second green point-light sources 222 and 223 are emitted may be different from each other. Still furthermore, points in time when and periods during which each of the blue point-light sources 224 are emitted may be different from each other.

Each of the point-light sources includes, for example, a light-emitting diode (“LED”) that emits a light beam and an optical lens (not shown) that surrounds the LED and diffuses the light beam that is emitted from the LED.

For example, the red point-light source 221 includes a red LED that emits a red light beam, and a first optical tens that covers the red LED and diffuses the red light beam. The first green point-light source 222 includes a first green LED that emits a first green light beam, and a second optical lens that covers the first green LED and diffuses the first green light beam. The second green point-light source 223 includes a second green LED that emits a second green light beam, and a third optical lens that covers the second green LED and diffuses the second green light beam. The blue point-light source 224 includes a blue LED that emits a blue light beam, and a fourth optical lens that covers the blue LED and diffuses the blue light beam.

In FIG. 1, the optical cluster includes, for example, one red point-light source, two green point-light sources and one blue point-light source. Alternatively, the optical cluster may include one red point-light source, one green point-light source and one blue point-light source.

The circuit boards 210 are spaced apart from each other by a predetermined gap, and are disposed in parallel with each other. The optical clusters 220 are disposed in a zigzag shape with respect to the optical clusters 220 on adjacent circuit boards 210. For example, one of the optical clusters 220 included in a light-generating unit 200, is disposed between two other optical clusters 220 included in an adjacent light-generating unit.

The light-generating unit 200 includes a light-receiving structure 230. The light-receiving structure 230 includes a transparent material. For example, the light-receiving structure 230 includes a material having a high refractive index, such as polymethylmethacrylate (“PMMA”), polycarbonate (“PC”) and/or methacrylate-styrene copolymer (“MS”). The light-receiving structure 230 is disposed in an emitting area of one optical cluster of the optical clusters 220, and receives a light beam that is generated from one of the optical clusters 220. The emitting area means the area reached by the light from the optical cluster. For one example, the light-receiving structure 230 may be disposed adjacent to at least of one optical cluster of the optical clusters 220. For another example, the light-receiving structure 230 is disposed within the emitting area that is surrounded by the point-light sources 221, 222, 223 and 224 corresponding to one optical cluster 220.

The light-receiving structure 230 may be disposed in an area corresponding to an outer area of the LCD panel unit 300, such as a corner of the LCD panel unit 300.

The light-generating unit 200 may further include a light sensor (or a color sensor) 240 that senses each of the red, green and blue light beams. In FIG. 1 the color sensor 240 is described as being spaced apart from the light-receiving structure 230. Alternatively, the color sensor 240 may be disposed at an end portion of the light-receiving structure 230, and may sense the red, green and blue light beams via the light-receiving structure 230.

The optical clusters 220 may be disposed on one of the circuit boards 210 in a plurality of columns. In another example, the circuit boards 210 may be disposed at an outer side of the receiving container 100, and the optical clusters 220 may be disposed in an inner side of the receiving container 100.

The LCD panel unit 300 includes an LCD panel 310 that displays images using the light beams that are provided from the light-generating units 200, and using a driving circuit section 320 that drives the LCD panel 310.

The LCD panel 310 includes a first substrate 312, a second substrate 314 that is positioned opposite to the first substrate 312, and a liquid crystal layer (not shown) that is interposed between the first and second substrates 312 and 314.

The first substrate 312 may be a thin-film transistor (“TFT”) substrate including a plurality of TFTs arranged in a matrix. For example, the first substrate 312 includes a glass material. The TFT includes a source terminal that is electrically connected to a data line, a gate terminal that is electrically connected to a gate line, and a drain terminal that is electrically connected to a pixel electrode. The pixel electrode includes a transparent conductive material.

The second substrate 314 is a color filter substrate, which has red-green-blue (“RGB”) pixels to produce color, and is formed as a thin film. The second substrate 314 includes, for example, a glass material. A common electrode including a transparent conductive material is formed on the second substrate 314.

When a gate voltage is applied to the gate electrode of the TFT, the TFT is turned on, so that a data voltage is applied to the pixel electrode through the TFT. When the data voltage is applied to the pixel electrode, electric fields are generated between the pixel electrode and the common electrode to change an orientation of the liquid crystal molecules in the liquid crystal layer that is interposed between the first substrate 312 and the second substrate 314. When the orientation of the liquid crystal molecules is changed, optical transmissivity of the liquid crystal layer is changed to display an image when the light beams generated from the light-generating unit 200 pass through the liquid crystal layer.

The driving circuit section 320 includes a data printed circuit board (“PCB”) 321, a gate PCB 322, a data driving circuit film 323 and a gate driving circuit film 324. The data PCB 321 provides the LCD panel 310 with a data driving signal. The gate PCB 322 provides the LCD panel 310 with a gate driving signal. The data driving circuit film 323 electrically connects the data PCB 321 to the LCD panel 310. The gate driving circuit film 324 electrically connects the gate PCB 322 to the LCD panel 310.

A tape carrier package (“TCP”) or a chip-on-film (“COF”) may be employed as the data and gate PCBs 321 and 322. When the LCD panel 310 includes a gate driving circuit, the gate PCB 322 is not required.

The LCD device may further include a power-providing apparatus 410 that generates a driving voltage for the light-generating units 200. The driving voltage that is generated from the power-providing apparatus 410 is applied to the light-generating units 200 through a first power line 412.

The power-providing apparatus 410 controls a driving voltage that is provided to the light-generating units 200, in response to the light-sensing signal that is provided from the color sensor 240 through a second power line 242.

For example, when the light-sensing signal that is provided from the color sensor 240, includes a relatively strong red light beam, a relatively weak green light beam, and a relatively weak blue light beam, the power-providing apparatus 410 provides the red LED of the light-generating unit 200 with a relatively low driving voltage, and provides the green and blue LEDs of the light-generating unit 200 with a relatively high driving voltage, respectively. Therefore, white balance control may be achieved in the light-generating unit 200 including LEDs that emit different light beams.

The LCD device may further include an optical member 420 that is disposed on the light-generating units 200. The optical member 420 is spaced apart from the LED for sufficiently mixing the red light beam, the green light beam and the blue light beam.

The optical member 420 includes a diffusion plate 422 that diffuses light beams emitted from the LED, and an optical sheet 424 that is disposed on the diffusion plate 422.

The diffusion plate 422 diffuses the light beams emitted from the LED to enhance brightness uniformity of the light beams. The diffusion plate 422 has a plate shape with a predetermined thickness and is spaced apart from the LED. The diffusion plate 422 may include a material, such as polymethylmethacrylate (“PMMA”) and a diffusing agent mixed with polymethylmethacrylate.

The optical sheet 424 changes a path of the light beams diffused by the diffusion plate 422 to improve the brightness characteristics of the light. The optical sheet 424 may include a condensing sheet that condenses the diffused light beams to a front direction (i.e., toward the LCD panel unit 300), thereby enhancing front-view brightness of the light. The optical sheet 424 may further include a diffusing sheet that further diffuses the light beams that have been diffused by the diffusion plate 422, thereby enhancing the brightness uniformity of the light in accordance with the brightness characteristics of the LCD device. Various optical sheets may be applied as the optical sheet 424.

Alternatively, a light-guiding member (not shown) may be further disposed below the optical member 420. The light-guiding member may be spaced apart from the light-generating units 200 with a predetermined gap. The light-guiding member mixes the red light beam, the green light beam and the blue light beam, and then a white light beam is emitted from the light-guiding member. The light-guiding member includes, for example, polymethylmethacrylate (“PMMA”).

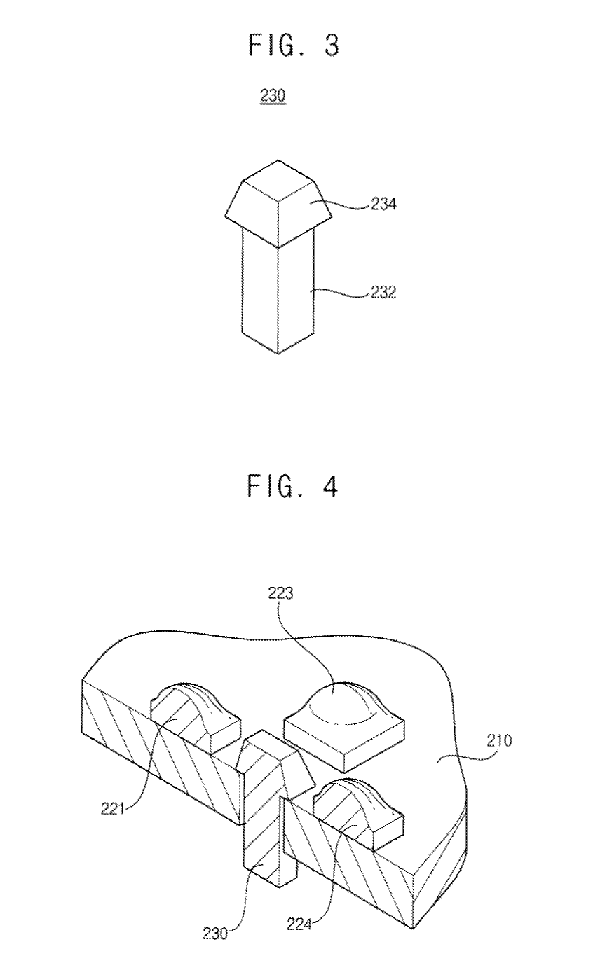

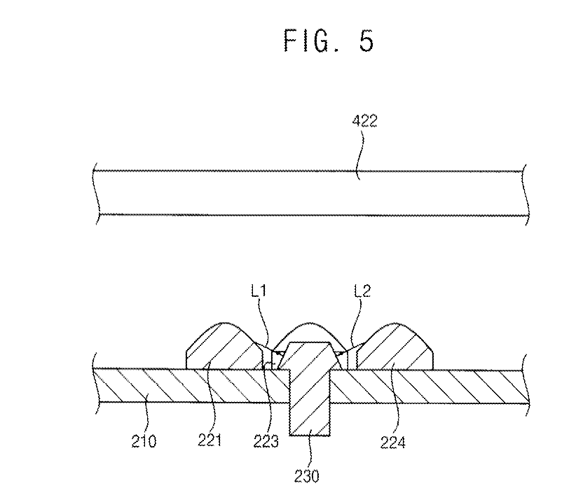

FIG. 3 is a perspective view illustrating a light-receiving structure in FIG. 1. FIG. 4 is a perspective cross-sectional view illustrating an optical cluster and a light-receiving structure in FIG. 1. FIG. 5 is a cross-sectional view schematically illustrating a light-receiving structure receiving light beams according to an exemplary embodiment of the present invention.

Referring to FIGS. 1 to 5, the light-receiving structure 230 includes a body section 232 having a square column shape, and a sensing section 234 that is disposed on the body section 232.

The body section 232 is inserted into a groove that is formed in one of the circuit boards 210. The sensing section 234 includes first to fourth light-receiving surfaces facing the red point-light source 221, the first and second green point-light sources 222 and 223, and the blue point-light source 224, respectively. The first to fourth light-receiving surfaces may be inclined, for example, substantially inclined, with respect to the plane formed by the circuit board 210 on which the point-light sources are disposed, and with respect to a plane including light emitted from the point-light sources 221, 222, 223 and 224. For example, the first to fourth light-receiving surfaces may be substantially perpendicular to the path of light emitted from the point-light sources 221, 222, 223 and 224. An upper portion of the sensing section 234 is connected to the first to fourth light-receiving surfaces. The upper portion of the sensing section 234 may face the diffusion plate 422.

When the point-light sources 221, 222, 223 and 224 emit different light beams, the emitted light beams are provided to the diffusion plate 422. A portion of light beam that is not provided to the diffusion plate 422 is provided to the sensing section 234 of the light-receiving structure 230.

For example, a red light beam L1 emitted from the red point-light source 221 is incident onto a first light-receiving surface of the sensing section 234, and a blue light beam L2 emitted from the blue point-light source 224 is incident onto a second light-receiving surface of the sensing section 234. Also, the first and second green light beams emitted from the first and second green point-light source 222 and 223 are incident onto third and fourth light-receiving surfaces, respectively.

Therefore, the red, green and blue light beams that are incident onto the sensing section 234 of the light-receiving structure 230 are provided to the color sensor 240 via the body section 232 of the light-receiving structure 230.

The uppermost portion of the light-receiving structure 230 is not higher than the uppermost portion of the point-light sources 221, 223 and 224.

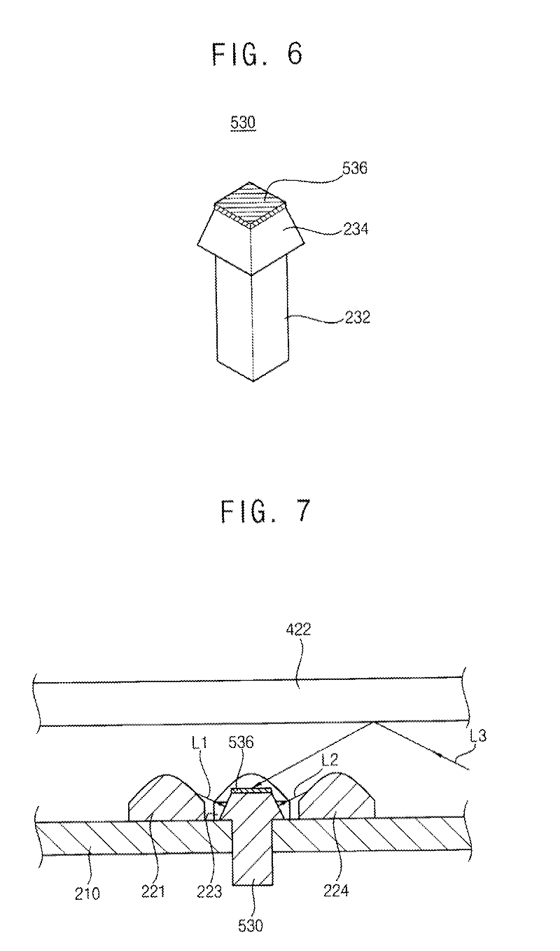

FIG. 6 is a perspective view illustrating a light-receiving structure according to an exemplary embodiment of the present invention. FIG. 7 is a cross-sectional view schematically illustrating a light-receiving structure of an optical cluster having the light-receiving structure in FIG. 6.

Referring to FIGS. 6 and 7, a light-receiving structure 530 according to an exemplary embodiment of the present invention includes a body section 232 having a square column, a sensing section 234 that is disposed on the body section 232 and a light-blocking member 536 that is disposed on the sensing section 234

The light-blocking member 536 is disposed in parallel with a plane that is defined by the sensing section 234. The light-blocking member 536 may include, for example, a material that absorbs the incident light beam to block a transmittance of the light beam, such as a black material. In another example, the light-blocking member 536 may include a material that blocks transmittance of the light beam and reflects an incident light beam from the outer side, such as aluminum or another metal.

As the point-light sources 221, 222, 223 and 224 emit different light beams, light beams are provided to the diffusion plate 422. A portion of the light beams that is not provided to the diffusion plate 422 is provided to the sensing section 234 of the light-receiving structure 530. For example, a red light beam L1 emitted from the red point-light source 221 is incident onto a first light-receiving surface of the sensing section 234, and a blue light beam L2 emitted from the blue point-light source 224 is incident onto a second light-receiving surface of the sensing section 234. Also, the first and second green light beams emitted from the first and second green point-light source 222 and 223 are incident onto third and fourth light-receiving surfaces, respectively.

An adjacent light beam L3 of the emitted light beam from an adjacent optical cluster, which is reflected by the diffusion plate 422, is blocked by the light-blocking member 536. Therefore, the adjacent light beam L3 is not absorbed into the optical cluster having the light-receiving structure 530, so that interference with the light beams emitted from the point-light sources is prevented.

As described above, according to the embodiments of the present invention the light-receiving structure having the light-receiving surfaces formed thereon is disposed adjacent to the LEDs. The light-receiving surfaces may be formed in the light-receiving structure in order to receive light beams emitted from the LEDs, such as light beams substantially perpendicular to the light-receiving surfaces. The light beams are emitted from point-light sources, for example, the LEDs that are disposed within a unit optical cluster. The light-receiving structure receives the light beams that are emitted from each of the LEDs. The power-providing apparatus provides each of the LEDs with power that is controlled in response to the received the light beams. Therefore, the white balance is controlled by mixing the different light beams emitted from each of the LEDs.

Furthermore, the light-blocking member may be disposed on an upper portion of the light-receiving structure, so that interference with the light beams that are emitted from the point-light sources, for example, the LEDs that are disposed within a unit optical cluster, may be prevented. Accordingly, the light interference may be minimized, so that white balance may be controlled in response to light intensities of the LEDs for each color.

Although exemplary embodiments of the present invention have been described, it is understood that the present invention should not be limited to these exemplary embodiments but various changes and modifications can be made by one of ordinary skill in the art within the spirit and scope of the present invention as hereinafter claimed.

What is claimed is:

1. A backlight assembly comprising:
an optical cluster including a plurality of point-light sources that emit different light beams;
a light-receiving structure disposed within an emitting area of the optical cluster, the light-receiving structure receiving the light beams emitted from the point-light sources;
a light sensor connected to the light-receiving structure, the light sensor sensing the light beams received from the light-receiving structure; and
a circuit board on which the optical cluster is mounted.

2. The backlight assembly of claim 1, further comprising a power-providing apparatus that provides each of the point-light sources with power,
wherein the power-providing apparatus controls a driving voltage applied to each of the point-light sources in response to a light-sensing signal transmitted by the light sensor to the power-providing apparatus.

3. The backlight assembly of claim 1, wherein each of the point-light sources are disposed on the same plane.

4. The backlight assembly of claim 3, wherein each of the point-light sources comprises a light-emitting diode.

5. The backlight assembly of claim 1, wherein the optical cluster comprises a red light-emitting diode, a blue light-emitting diode and a green light-emitting diode.

6. The backlight assembly of claim 1, wherein the optical cluster comprises one red light-emitting diode, one blue light-emitting diode and two green light-emitting diodes.

7. The backlight assembly of claim 1, wherein the light-receiving structure comprises a plurality of light-receiving surfaces facing each of the point-light sources, respectively.

8. The backlight assembly of claim 7 wherein each of the light-receiving surfaces is substantially inclined with respect to a plane on which the point-light sources are disposed.

9. The backlight assembly of claim 7, wherein each of the light-receiving surfaces is substantially perpendicular to a path of light emitted from the point-light sources, respectively.

10. The backlight assembly of claim 1, further comprising a diffusion plate that diffuses the different light beams emitted from the optical cluster.

11. The backlight assembly of claim 10, wherein the diffusion plate reflects portions of the different light beams, and the light-receiving structure further comprises a light-blocking member that blocks the portions of the different light beams reflected by the diffusion plate.

12. The backlight assembly of claim 11, wherein the light-blocking member is disposed on an upper portion of the light-receiving structure, the upper portion of the light-receiving structure facing the diffusion plate.

13. The backlight assembly of claim 1, wherein a plurality of the optical clusters are disposed on a plane,
and the light-receiving structure is disposed in one of the optical clusters located adjacent to an edge of the backlight assembly.

14. The backlight assembly of claim 1, wherein the light-receiving structure is inserted into an opening formed on the circuit board.

15. The backlight assembly of claim 1, wherein the light sensor senses an intensity of each light beams that are emitted from the point-light sources, respectively.

16. The backlight assembly of claim 1, wherein the light-receiving structure is within the optical cluster.

17. The backlight assembly of claim 1, wherein the uppermost portion of the light-receiving structure is not higher than the uppermost portion of the point-light sources.

18. A liquid crystal display (“LCD”) device comprising:
an LCD panel displaying images using a liquid crystal layer that is interposed between two substrates; and
a backlight assembly including an optical cluster and a light-receiving structure disposed within an emitting area of the optical cluster, the backlight assembly providing the LCD panel with light.

19. The LCD device of claim 18, wherein the backlight assembly including a plurality of the optical clusters.

20. The LCD device of claim 19, wherein the light-receiving structure is within an outermost optical cluster of the plurality of the optical cluster.

21. The LCD device of claim 18, wherein the optical cluster comprises a plurality of point-light sources.

22. The LCD device of claim 21, wherein the optical clusters are disposed on a plane.

23. The LCD device of claim 18, further comprising:
a diffusion plate disposed above the optical clusters, the diffusion plate diffusing and reflecting light beams that are emitted from the optical clusters,
wherein the light-receiving structure comprises a light-blocking member that blocks the light beams reflected by the diffusion plate.

24. The LCD device of claim 23, wherein the light-blocking member includes a black material.

25. The LCD device of claim 23, wherein the light-blocking member includes a metal that reflects the light beams reflected by the diffusion plate.
